(19) United States
(12) Patent Application Publication
(10) Pub. No.: US 2002/0008113 A1
(43) Pub. Date: Jan. 24, 2002

(54) THERMALLY INSULATED SYNTHETIC RESIN CONTAINER AND THERMALLY INSULATED SYNTHETIC RESIN LID

(76) Inventors: TAKAFUMI FUJII, TOKYO (JP); MASASHI YAMADA, TOKYO (JP); ATSUHIKO TANAKA, TOKYO (JP)

Correspondence Address: DARBY & DARBY, 805 THIRD AVENUE, NEW YORK, NY, 10022

(21) Appl. No.: 09/260,176

(22) Filed: Mar. 1, 1999

(30) Foreign Application Priority Data
Mar. 19, 1998 (JP) 10-070867

(51) Int. Cl. A47J 39/00; A47J 41/00; B65D 81/38; B65D 83/72

(52) U.S. Cl. 220/592.2; 220/592.27

(57) ABSTRACT

The present invention relates to a thermally insulated synthetic resin container and a thermally insulated synthetic resin lid. The synthetic thermally insulated container has a thermally insulating layer formed in the space between the inner container and the outer container, which comprise at least one synthetic resin selected from among the group comprising polyester, aromatic polyamide, polyketone, polyvinylidenefluoride, acrylonytrile-type resin, and cycloolefin-type resin, with a low thermally conductive gas having a thermal conductivity lower than air sealed therein. Similarly, the thermally insulated synthetic resin lid has an thermally insulating layer formed in the space between the synthetic resin lower lid member and the upper lid member. The thermally insulated synthetic resin container and lid can be made from only one type of resin, are easy to manufacture, and are superior in thermal insulation performance and maintaining thermal insulation performance over time.

### FIELD OF THE INVENTION

The present invention relates to a thermally insulated container and a thermally insulated lid used in thermos bottles, cooler boxes, ice boxes, insulating cups, heat-retaining lunch boxes, etc., and in particular relates to a thermally insulated synthetic resin container and thermally insulated synthetic resin lid having a thermally insulating layer consisting of a low thermally conductive gas is enclosed in the space between the walls of a synthetic resin double walled structure.

This application is based on Japanese patent Application No. Hei 10-70867, the contents of which are incorporated herein by reference.

### BACKGROUND ART

Conventionally, in thermally insulated container used for thermos bottles, heat retaining lunch boxes, insulated cups, etc., the development and manufacture of thermally insulated synthetic resin containers, which have the advantages of light weight, ease of molding, low production cost, etc., have been promoted. As the thermally insulated synthetic resin container, there is a type of thermally insulated container formed by accommodating a synthetic resin inner container inside a synthetic resin outer container which is somewhat larger in size and has roughly the same in shape. A space is provided therebetween, their respective edge portions of opening are joined and made integral to produce a double-walled container, and an thermally insulating layer is formed by filling at least one low thermally conductive gas selected from among krypton, xenon and argon in this space.

In the thermally insulated container which is obtained by filling gas in the space formed between the inner and outer container, in order to maintain their thermal insulation performance, it is important to provide a layer having a gas barrier capabilities such that this enclosed gas does not permeate the container wall from the thermally insulating layer, and specifically, it is necessary to use a synthetic resin with a high gas barrier capabilities, or as a different embodiment, dispose a metal plating layer on the sides of the space in between the inner and outer containers.

The following is a conventional example of this type of thermally insulated synthetic resin container.

A thermally insulated synthetic resin container and a manufacturing method for the same providing a synthetic resin having a gas barrier capabilities on the inner surface of a synthetic resin having a hot water resistance are disclosed in Japanese Patent Application, First Publication, No. Hei 8-282742, Japanese Patent Application, First Publication, No. Hei 10-164, and Japanese Patent Application, First Publication, No. Hei 9-24978.

Japanese Patent Application, First Publication, No. Hei 8-282742, discloses a double walled structure thermally insulated synthetic resin container wherein a synthetic resin inner container is disposed in a synthetic resin outer container so as to provide a space, the respective openings of the inner container and the outer container are joined and made integral, at the same time forming a thermally insulating layer in the space between the inner container and outer container. A metal plating layer is provided on the outer surface of the inner container and the inner surface of the outer container, except at the contact portion between the inner container and outer container, the opening of the inner container and the opening of the outer container are joined and made to form an integral structure, and a low thermally conductive gas is enclosed in the space between the inner and outer container.

In this conventional thermally insulated synthetic resin container, a metal plating layer is formed for providing gas barrier capabilities. However, when forming a metal plating, because there are cases in which the joint is not satisfactory when metal plating remains on the joining portion, strict control is required so that a metal plating does not form on the joining part of the opening of the inner container and the opening of the outer container. In order to accomplish this, it is necessary to mask the part on which the metal plating is not formed. A high precision is required for this masking. Because a metal plating must be formed on the outer surface of the inner container and the inner surface of the outer container in this manner, and because a high precision masking is required, there is the problem that the cost is increased.

In addition, in Japanese Patent Application, First Publication, No. Hei 10-164, a following method disclosed; an inner wall element and an outer wall element using a synthetic resin having a gas barrier capabilities are formed, and the inner and outer wall elements jointed and made integral, thus an inner layer body is manufactured. Next, the inner layer body is filled with a low thermally conductive gas having a thermal conductivity lower than air from a filling opening, and by sealing this filling opening an thermally insulating inner layer body is manufactured. The synthetic resin inner and outer containers having heat resistance and chemical resistance are formed separately, and the inner layer body enclosing the gas is inserted in the space formed between the inner and outer containers, and the inner and outer containers are joined and made integral.

However, the thermally insulated containers disclosed in this publications have a four part structure comprising an inner wall element and an outer wall element as an inner layer body, and an inner container and an outer container, and have many components. In addition, a two-stage joining (fusion) operation, wherein the inner wall element and the outer wall element are joined and then the inner container and outer container are joined, is necessary. Hence, there is the problem that the number of steps increases.

In addition, in order to intervene the inner layer body in the space between the outer container and the inner container, very precise control of the dimensions is necessary. For example, if the dimension of the inner layer body is smaller than the dimension of the space, the inner layer body will move around inside the space, producing a strange sound. In addition, contrariwise, there is also the problem that when the dimension of the inner layer body is larger than the dimension of the space, it cannot be enclosed in the space, and the inner container and outer container cannot be joined and made integral.

Furthermore, Japanese Patent Application, First Publication, No. Hei 9-24978 discloses a method of forming a thermally insulated synthetic resin container using what is called a multi-color molding machine. This is a molding method of a synthetic resin having gas barrier capabilities and a hot water resistance in one-step injection molding, and when forming the inner container and outer container with this multi-color molding machine, wherein two layers of synthetic resin are overlaid and formed by being made integral, they are formed so that the synthetic resin facing the space has a gas barrier capabilities and the synthetic resin facing the air has heat-resistance and chemical resistance. After that, the inner and outer containers are joined and made integral, and a low thermally conductive gas is enclosed in the space between the inner and outer containers.

In this method, it is possible to carry out the molding all at once, but when formed in a multi-color molding machine, there is the problem that continuous injection steps and cooling steps equal to the number of resin layers are necessary, and much time is required until all processes are complete. In addition, the structure of the metal mold is complicated, and therefore the cost of producing it is high. In addition, the cost of the multi-color molding machine itself is high, so the manufacturing equipment cost is high.

### SUMMARY OF THE INVENTION

In consideration of the above, it is an object of the present invention to provide thermally insulated synthetic resin container having the inner and outer containers produced with only one type of resin, is easy to manufacture, and is superior in thermal insulation performance and maintaining the quality of the thermal insulation performance over time.

The thermally insulated synthetic resin container of the present invention is characterized in forming a thermally insulating layer by enclosing a low thermally conductive gas with a thermal conductivity lower than air in the space between the inner container and the outer container of a double walled synthetic resin container, and at least one type of synthetic resin selected from among the group comprising polyester, aromatic polyamide, polyketone, polyvinylidenefluoride, acrylonitrile-type resin, and cycloolefin-type resin, is used in making the inner container and outer container.

The synthetic resin insulating lid of the present invention is characterized in forming a thermally insulating layer by enclosing a low thermally conductive gas with a thermal conductivity lower than air in the space between the upper lid member and the lower lid member of a double walled synthetic resin lid, and at least one type of synthetic resin selected from among the group comprising polyester, aromatic polyamide, polyketone, polyvinylidenefluoride, acrylonitrile-type resin, and cycloolefin-type resin, is used in making the upper lid member and lower lid member.

In a thermally insulated synthetic resin container and a thermally insulated synthetic resin lid having an thermally insulating layer with a low thermally conductive gas filled therein, even in the welding process of the inner and outer containers or the upper and lower lid members, the present invention does not require any special preheating, and can be carried out simply and satisfactorily because the container and the lid are formed from at least one synthetic resin selected from among the group comprising polyester, aromatic polyamide, polyketone, polyvinylidenefluoride, acrylonitrile-type resin, and cycloolefin-type resin. Furthermore, the capability to maintain the airtightness of the gas enclosed in the space is high. Therefore, a favorable heat retention performance can be maintained over a long period of time.

In addition, these synthetic resins can greatly ameliorate the problem of the transfer of smell in cooking vessels, cooler boxes, mugs, etc., because their absorbency is low and their chemical resistance is superior.

Furthermore, the wall of the thermally insulated container can be made thin, and it can be designed to be light weight, in addition to increasing the effective volume ratio (the proportion of the inner volume relative to the size of the outside of the container).

### BRIEF DESCRIPTION OF THE DRAWINGS

FIG. 1 is a cross-sectional diagram showing an embodiment of the thermally insulated synthetic resin container and thermally insulated synthetic resin lid of the present invention.

FIG. 2 is a graph showing the result of a heat-retention performance test of the first embodiment according to the present invention.

FIG. 3 is a graph showing the result of a heat-retention performance test of the second embodiment according to the present invention.

FIG. 4 is a graph showing the result of a heat-retention performance test of the third embodiment according to the present invention.

### DETAILED DESCRIPTION OF TIE PREFERRED EMBODIMENTS

The thermally insulated synthetic resin container (hereinbelow, referred to as the “insulated container”) and the thermally insulated synthetic resin lid (hereinbelow, referred to as the “insulated lid”) of the present invention form an thermally insulating layer by enclosing a low thermally conductive gas with a thermal conductivity lower than air in the space in the synthetic resin double walled structure (the double walled container and the double walled lid), and are formed from at least one synthetic resin selected from among the group comprising polyester, aromatic polyamide, polyketone, acrylonitrile-type resin, and cycloolefin-type resin as the synthetic resin for the double walled structure.

As a low thermally conductive gas used in the present invention, at least one type of gas selected from among the group comprising xenon, krypton, and argon is appropriate.

The used resin is preferably a synthetic resin having excellent heat resistance, water resistance (moisture permeability resistance), and mechanical strength. Specifically, it is a synthetic resin having a moisture permeability of 50 g/m²/24 hr at a temperature of 40° C. and a relative humidity of 90% according to the standards of JIS Z0280, and a modulus of elasticity (ASTM D790) of 10,000 kg/cm² or greater, and/or an Izod impact strength (notched) (ASTM D256) of 20 J/m or greater. Furthermore, it is preferable that the synthetic resin material be a synthetic resin providing a superior gas barrier, specifically having a gas permeability of film (ASTM D1434-58) of 300 (cc·mm)/m²/24 hr/atm (object gases: O₂, N₂, CO₂) or less, and preferably of 50 or less.

Among the resin materials used in the present invention, as a polyester, aromatic polyesters such as polyethyleneterephthalate, or polyethylenenaphthalate, polybutylenenaphthalate, liquid crystal polymers (LCP), etc., can be included.

In addition, as an aromatic polyamide, polyamide and amorphous nylon can be included.

In addition, as a polyketone, aromatic polyketone, aliphatic polyketone, etc., can be included.

In addition, as an acrylonitryl-type resin, polyacrylonitryl, polymethylmethacrylate, etc., can be included.

In addition, as a cycloolefin-type resin, cycloolefin polymer and cyclohexadiene can be included.

These resins, in addition to being used alone, can be used as alloy resins wherein miscible resins are mixed together.

Even in the welding step of the inner and outer container and the upper and lower lid, these synthetic resins do not require any special pre-heating, and can be carried out simply and satisfactorily. Furthermore, the capacity to maintain the airtightness of the gas sealed in the space is high. Therefore, it is possible to maintain the heat retention performance over a long period of time.

In addition, these synthetic resins greatly decrease the problem of the transfer of smell even when used in cooking vessels, cooler boxes, and mugs because they have low absorbency and chemical resistance.

Furthermore, it is possible to make the wall of the insulated container thin, and have a light weight design, in addition to increasing the effective volume ratio (the proportion of the inner volume to the size of the outside).

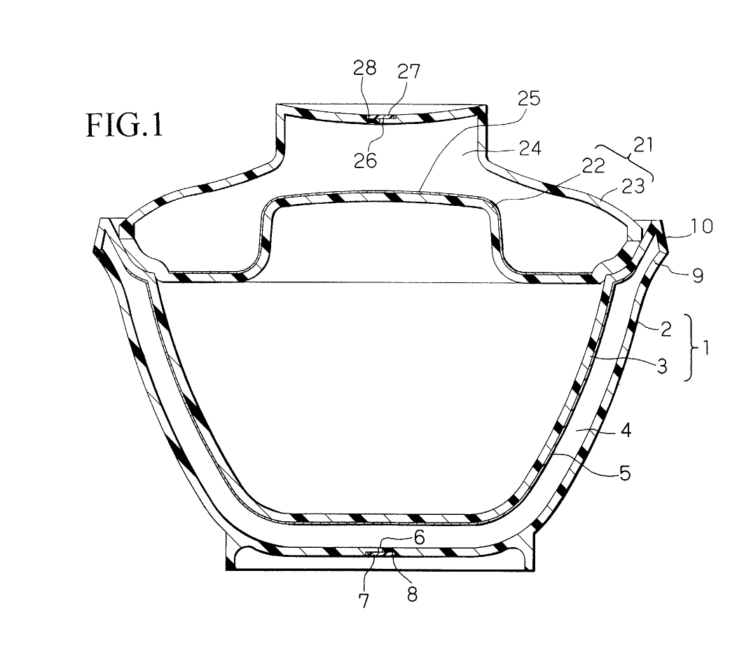

The embodiments of the insulated container and insulated lid of the present invention will be explained referring to the drawings. FIG. 1 shows a thermally insulated table ware comprising a insulated container and a insulated lid as an embodiment of the present invention.

The thermally insulated container 1 is formed by accommodating a synthetic resin inner container 3 inside a synthetic resin outer container 2 so as to provide a space, joining the edge of the outer container 9 and the edge of the inner container 10 together as one by vibrational welding and spin welding, and an thermally insulating layer 4 is formed by filling at least one type of low thermally conductive gas selected from among the group comprising xenon, krypton, and argon between the inner container 3 and the outer container 2. At the center of the bottom of the outer container 2, a concavity 8 is formed, and at the center of this concavity 8, an opening 6 to the thermally insulating layer 4 is bored. In the concavity 8, a sealing plate 7 comprising the same resin as the outer container 2 is inserted. This sealing plate 7 is fixed airtight to the bottom surface of the concavity 8 by an adhesive such as a cyanoacrylate adhesive.

On the outer surface of the inner container 10, a metallic plating for preventing radiation comprising copper foil, aluminum foil, etc., is attached.

Moreover, instead of metal foil 5, by applying a synthetic resin film having a high degree of infrared reflectivity and a coating incorporating a ceramic reflector powder, it is possible to obtain a certain degree of a radiation prevention effect, and at the same time, by not using the metal foil, the insulated container 1 can be placed directly in a microwave oven, making possible microwave heating.

This insulated container 1 has as its raw material a resin selected from each type of synthetic resin described above, forms the outer container 2 and the inner container 3 by injection molding, and after the metal foil 5 is attached to the outer surface of the inner container 3, the inner container 3 is enclosed in the outer container 2, and the respective edges 9, 10 are welded by spin welding or vibration welding, etc., making a double walled container. Next, from the opening 6 bored in the bottom of the outer container 2, the space between the containers is evacuated, and then filled with a low thermally conductive gas to about atmospheric pressure. Then a cyanoacrylate adhesive is applied to the concavity 8 on the outer container 2, the sealing plate, manufactured separately, is inserted and anchored, and the opening 6 is sealed.

In addition, the insulated lid 21 has the same structure as the above-described insulated container 1, and is manufactured by the same manufacturing processes. That is, a resin is selected from among each type of the above-described synthetic resins as the raw material, the lower lid member 22 an the upper lid member 23 are formed by injection molding, a metal foil 25 is attached to the upper surface of the lower lid member 22, the lower lid member 22 and the upper lid member 23 are assembled, and their respective edges are welded by spin welding or vibration welding, etc., to make a double walled lid. Next, from an opening 26 bored in the top of the upper lid member 23, the inside space is evacuated, and then filled with a low thermally conductive gas to about atmospheric pressure. Then a cyanoacrylate adhesive is applied to the concavity 28 in the upper lid member 23, and a sealing plate 27, produced separately, is inserted and anchored, and the opening 26 is sealed.

Below, the insulated container 1 and the insulated lid 21 shown in FIG. 1 are produced using each type of synthetic resin, and the result of performance tests are explained.

### EXAMPLE 1

The insulated container 1 was produced using polyethylenenaphthalate (Mitsubishi Chemical, Inc.,: NC 900 Z), which is an aromatic polyester, as the material. The thickness of the inner container 3 and the outer container 2 was varied between 0.5˜5.0 mm, and the insulated container 1 made of polyethylnaphthalate using an inner and outer container of different thicknesses were produced. As a sealed gas, krypton was used.

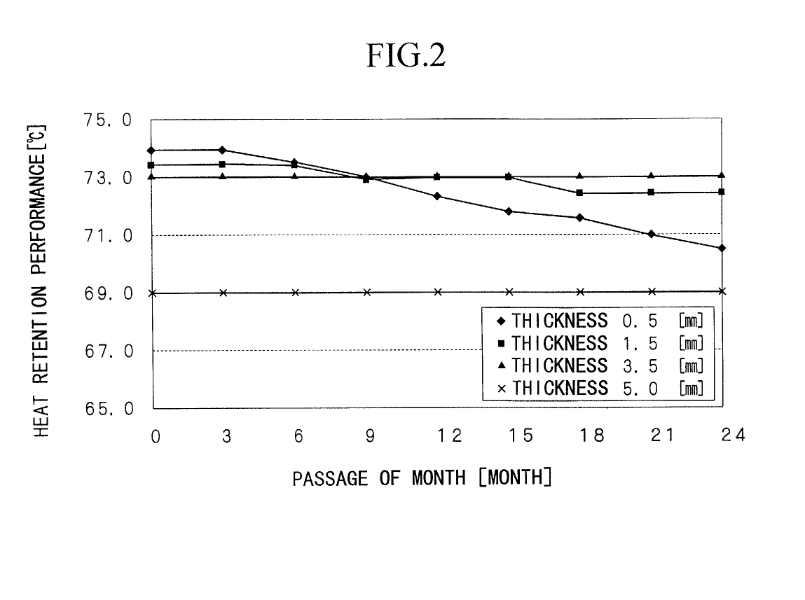

Using these insulated containers, the change in heat retention performance over time was studied for two years. The results are shown in FIG. 2. To find the heat retention performance, the insulated container was placed for one hour in a thermostatic chamber at 20° C., hot water at 95° C.±1° C. was placed therein, the insulating lid put in place, and the temperature of the water was measured after being placed in the thermostatic chamber for one hour.

It is clear from FIG. 2 that when the wall is thin, with the passage of time, deterioration in heat retention performance can be seen, but when the wall exceeds a certain thickness, no lowering of heat retaining capacity can be seen, and it is clear that a favorable heat retention performance can be maintained. However, if the wall is too thick, even though it is possible to prevent deterioration in the heat retention performance with the passage of time, the heat transfer loss via the joint at the opening becomes large, and because the thermal capacity of the resin increases, the initial heat retention performance decreases.

Furthermore, during the heat retention performance tests, hot water was placed in the thermally insulated synthetic resin container and maintained, but no moisture accumulated in the inner container. In addition, even if held in a dryer at 80° C. for about 20 minutes after use, there was almost no deformation, and it was possible to maintain a very appropriate shape.

From the above, it is clear that in order to maintain a high heat retention performance over a long period of time after the initial stage, there is no problem if the appropriate thickness is 1.5 mm or greater. Furthermore, when taking into consideration the use conditions of this bowl-shaped thermally insulated container, it is clear that setting the appropriate range of thickness between 1.5˜3.5 mm is realistic. Furthermore, when thermally insulated containers having other shapes and uses are employed, it is preferable to set the appropriate thickness depending in the conditions of use.

### EXAMPLE 2

The insulated container 1 was produced using LCP (Sumitomo Chemical, Inc.,: Sumika Super E 6808-W02), which is an liquid crystal polyester, as the material. The thickness of the inner container 3 and the outer container 2 was varied between 0.5˜3.0 mm with 0.5 mm interval, and the insulated container 1 was made of LCP using an inner and outer container of different thicknesses were produced. As a sealed gas, krypton was used.

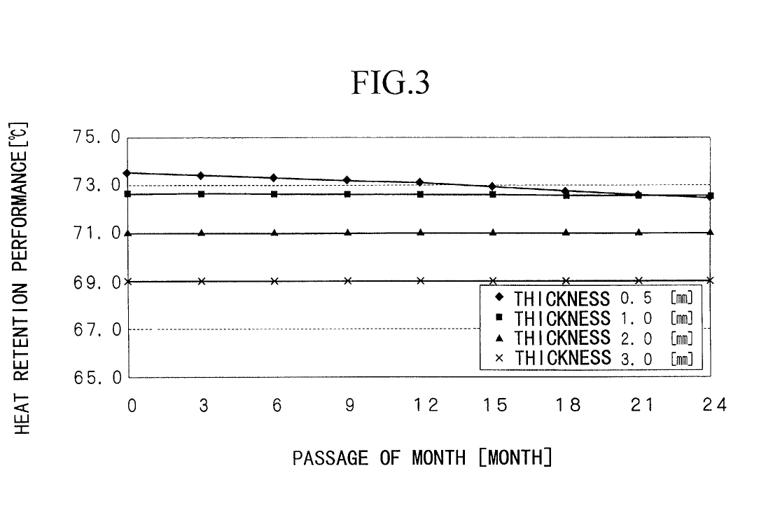

Using these insulated containers, the change in heat retention performance over time was studied for two years. The result is shown in FIG. 3. To find the heat retention performance, same as example 1, the insulated container was placed for one hour in a thermostatic chamber at 20° C., hot water at 95° C.±1° C. was placed therein, the insulating lid put in place, and the temperature of the water was measured after being placed in the thermostatic chamber for one hour.

It is clear from FIG. 3, same as FIG. 2, that there is an appropriate wall thickness for heat retention in a synthetic thermally insulated container for LCP as well.

Furthermore, during the heat retention performance tests, hot water was placed in the thermally insulated synthetic resin container and maintained, but no moisture accumulated in the inner container. In addition, even if held in a dryer at 80° C. for about 20 minutes after use, there was almost no deformation, and it was possible to maintain a very appropriate shape.

From the above, it is clear that in order to maintain a high heat retention performance over a long period of time after the initial stage, there is no problem if the appropriate thickness is 0.5 mm or greater. Furthermore, when taking into consideration the use conditions of this bowl-shaped thermally insulated container, it is clear that setting the appropriate range of thickness between 1.0˜2.5 mm is realistic. Furthermore, when insulated containers having other shapes and uses are employed, it is preferable to set the appropriate thickness depending in the conditions of use.

### EXAMPLE 3

The insulated container 1 was produced using aliphatic polyketone (Shell Japan, Inc.,: Carilon), which is an aliphatic polyketone, as the material. The thickness of the inner container 3 and the outer container 2 was varied between 1.0˜2.5 mm, and the insulated container 1 made of polyketone using an inner and outer container of different thicknesses were produced. As a sealed gas, krypton was used.

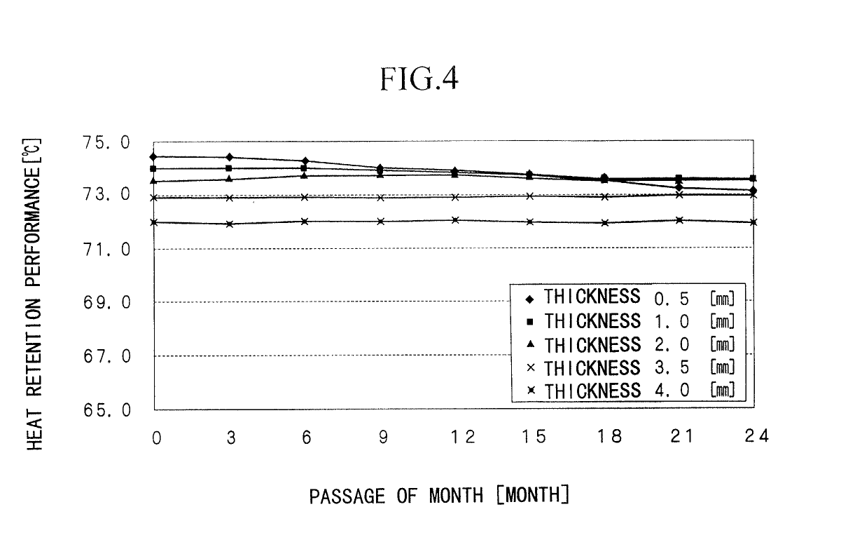

Using these insulated containers, the change in heat retention performance over time was studied for two years. The result is shown in FIG. 4. To find the heat retention performance, same as example 1 and example 2, the insulated container was placed for one hour in a thermostatic chamber at 20° C., hot water at 95° C.±1° C. was placed therein, the insulating lid put in place, and the temperature of the water was measured after being placed in the thermostatic chamber for one hour.

It is clear from FIG. 4, same as FIG. 2 and FIG. 3, that there is an appropriate wall thickness for heat retention in a synthetic thermally insulated container for polyketone as well.

Furthermore, during the heat retention performance tests, the hot water is placed in the thermally insulated synthetic resin container and maintained, but no moisture accumulated in the inner container. In addition, even if held in a dryer at 80° C. for about 20 minutes after use, there was almost no deformation, and it was possible to maintain a very appropriate shape.

From the above, it is clear that in order to maintain a high heat retention performance over a long period of time after the initial stage, there is no problem if the appropriate thickness is 1.0 mm or greater. Furthermore, when taking into consideration the use conditions of this bowl-shaped thermally insulated container, it is clear that setting the appropriate range of thickness between 1.0˜3.5 mm is realistic. Furthermore, when insulated containers having other shapes and uses are employed, it is preferable to set the appropriate thickness depending in the conditions of use.

### EXAMPLE 4

The insulated container 1 was produced using cycloolefin resin (Mitsui Chemical, Inc.,: APEL) as the material. The thickness of the inner container 3 and the outer container 2 was varied between 1.0˜4.0 mm with 1.0 mm interval, and the insulated container 1 made of cycloolefin resin using an inner and outer container of different thicknesses were produced. As a sealed gas, xenon was used.

Using these insulated containers, the change in heat retention performance over time was studied. To find the heat retention performance, the insulated container was placed for one hour in a thermostatic chamber at 20° C., hot water at 95° C.±1° C. was placed therein, the insulating lid put in place, and the temperature of the water was measured after being placed in the thermostatic chamber for one hour.

As a result, same as FIGS. 2˜4, there is an appropriate wall thickness for heat retention in a synthetic thermally insulated container for cycloolefin resin as well.

Furthermore, during the heat retention performance tests, the hot water is placed in the thermally insulated synthetic resin container and maintained, but no moisture accumulated in the inner container. In addition, even if held in a dryer at 80° C. for about 20 minutes after use, there was almost no deformation, and it was possible to maintain a very appropriate shape.

From the above, it is clear that in order to maintain a high heat retention performance over a long period of time after the initial stage, there is no problem if the appropriate thickness is 2.0 mm or greater. Furthermore, when taking into consideration the use conditions of this bowl-shaped thermally insulated container, it is clear that setting the appropriate range of thickness between 2.0˜4.0 mm is realistic. Furthermore, when thermally insulated containers having other shapes and uses are employed, it is preferable to set the appropriate thickness depending in the conditions of use.

What is claimed:

1. A thermally insulated synthetic resin container comprising;
a synthetic resin double walled container comprising an inner container and an outer container comprising at least one synthetic resin selected from among the group comprising polyester, aromatic polyamide, polyketone, polyvinylidenefluoride, acrylonytrile-type resin, and cycloolefin-type resin, and
a thermally insulating layer enclosed in the space between said inner container and outer container sealing in a low thermally conductive gas having a thermal conductivity lower than air.

2. A synthetic thermally insulated lid comprising;
a synthetic resin double walled lid comprising a lower lid member and an upper lid member comprising at least one synthetic resin selected from among the group comprising polyester, aromatic polyamide, polyketone, polyvinylidenefluoride, acrylonytrile-type resin, and cycloolefin-type resin, and
a thermally insulating layer enclosed in the space between said lower lid member and upper lid member sealing in a low thermally conductive gas having a thermal conductivity lower than air.
